(19) United States
(12) Patent Application Publication
(10) Pub. No.: US 2009/0003912 A1
(43) Pub. Date: Jan. 1, 2009

(54) CURL CORRECTING DEVICE AND IMAGE FORMING APPARATUS

(75) Inventors: Tsuyoshi Nagasaki, Toride-shi (JP); Kenichi Hirota, Joso-shi (JP); Hiroyuki Takahashi, Abiko-shi (JP); Hiromitsu Uchida, Toride-shi (JP); Hiroshige Inoue, Abiko-shi (JP); Yoshiyasu Satomi, Toride-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/145,424

(22) Filed: Jun. 24, 2008

(30) Foreign Application Priority Data
Jun. 26, 2007 (JP) 2007-167458

(51) Int. Cl. G03G 15/00

(52) U.S. Cl. 399/406

(57) ABSTRACT

A curl correcting device for correcting a curl of a sheet at a curved belt-nip portion includes an endless belt extending between a driving roller and a driven roller, and a pressing roller configured to press a belt surface of the endless belt. A stepping motor is controlled in accordance with a pressing amount of the pressing roller to the belt surface of the endless belt to adjust a speed of the endless belt, thereby preventing the speed from being decreased.

### BACKGROUND OF THE INVENTION

1. Field of the Invention

The present invention relates to a curl correcting device that corrects a curl generated at a sheet, and an image forming apparatus having the curl correcting device.

2. Description of the Related Art

In recent years, an image forming apparatus, such as a copier, a printer, or a facsimile, utilizing electrophotography, has been widely used. Also, to sort or bind sheets outputted from the image forming apparatus, there is an increase in demand for a post-processing device such as a finisher that sorts sheets, having images formed thereon, into groups each containing a desired number of sheets, or that processes sheets by stapling or punching.

The post-processing device may be affected by, for example, a heat curl generated when a sheet passes through a fixing device that fixes a toner image to a sheet by heating, or a curl generated when a sheet heated with the fixing device or the like passes through a curved sheet-conveying path. If a large curl is generated at a sheet, for example, the following problems may occur: sheets may be incorrectly stacked, a sheet may be misaligned, and stapling may fail, in the image forming apparatus.

To overcome such problems, a curl correcting device is provided that corrects a curl generated at a sheet, before a post-processing device performs post processing. For example, Japanese Patent Laid-Open No. 2001-294355 discloses a curl correcting device including an endless belt extending between a driving roller and a driven roller, and a rotatable pressing roller for pressing a belt surface of the endless belt. In this configuration, since the pressing roller presses the endless belt, a curved belt-nip portion (contact-pressure portion between the endless belt and the pressing roller) is formed. A sheet passes through the curved belt-nip portion, and hence, a curl of the sheet can be corrected.

A heat curl to be generated after fixing with a fixing device, may appear in a different state (different size) in accordance with a type of sheet, density of an image formed on a sheet, environmental humidity, or the like. Accordingly, Japanese Patent Laid-Open No. 6-115797 discloses a curl correcting device that adjusts a curl correcting amount (pressing amount of a pressing roller) in accordance with a predetermined parameter, such as type of sheet, or image density.

With such a curl correcting device, however, a change in the curl correcting amount (pressing amount of the pressing roller to the endless belt) may cause a jam (sheet jam) if a thin sheet having a small basis weight is used. In addition, a sheet may slip at a curved belt-nip portion. If the sheet slips at the belt nip portion, a slip mark may remain in a sheet, or an image fixed on the sheet.

### SUMMARY OF THE INVENTION

The present invention provides an image forming apparatus having a curl correcting device capable of providing stable sheet conveyance and image quality even when a curl correcting amount is changed.

According to an aspect of the present invention, a curl correcting device configured to correct a curl of a sheet, includes an endless belt extending between a driving roller configured to be rotationally driven, a driven roller configured to be driven with the driving roller and a pressing roller configured to press a belt surface of the endless belt. The sheet is conveyed through a curved belt-nip portion between the pressing roller and the endless belt so as to correct the curl of the sheet. The rotation speed of the driving roller is changeable in accordance with a pressing amount of the pressing roller to the endless belt.

Further features of the present invention will become apparent from the following description of exemplary embodiments with reference to the attached drawings.

### BRIEF DESCRIPTION OF THE DRAWINGS

FIG. 1 is a cross section showing an image forming apparatus according to an embodiment of the present invention.

FIG. 2 is a schematic illustration showing a curl correcting device according to an embodiment of the present invention.

FIG. 3 is a schematic illustration showing a belt in a pressed state.

FIG. 4 is a speed distribution diagram of the belt in the pressed state.

FIG. 5 is a relationship table showing a relationship between a pressing amount and a rotation speed of a driving roller.

FIG. 6 is a block diagram showing a configuration of a control unit of the curl correcting device.

FIG. 7 is a flowchart showing control of the curl correcting device.

### DESCRIPTION OF THE EMBODIMENTS

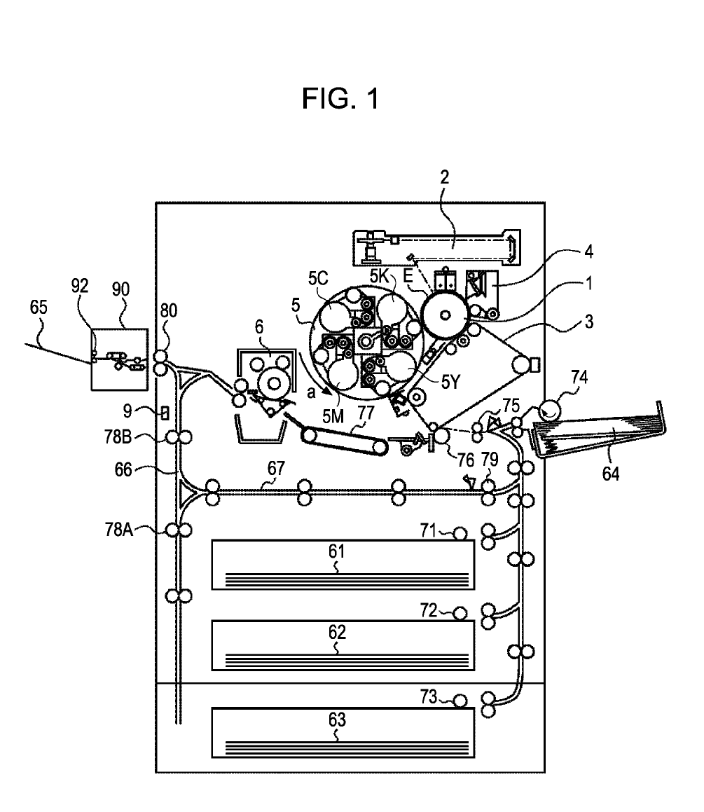

An image forming apparatus according to an embodiment of the present invention is described below. FIG. 1 is a cross section briefly showing the image forming apparatus. The entire configuration of the image forming apparatus is described with reference to FIG. 1.

Referring to FIG. 1, an image forming unit is described first. A photosensitive drum 1 functioning as an image bearing member is rotatably supported. A pre-exposure lamp, a corona charging unit, a laser exposure optical system 2, an electric potential sensor, an intermediate transfer member 3, a cleaning unit 4, and a rotary developing unit 5 are arranged around the photosensitive drum 1. The rotary developing unit 5 is rotatably arranged and includes four-color developers of a black developer 5K, a yellow developer 5Y, a magenta developer 5M, and a cyan developer 5C. The rotary developing unit 5 is rotated counterclockwise as indicated by arrow a in FIG. 1 around a cylindrical rotation shaft provided at the center of the rotary developing unit 5. The rotary developing unit 5 brings a desired-color developer to a development position facing the photosensitive drum 1 at a desired timing.

In the laser exposure optical system 2, a reader unit obtains an image signal, and a laser output unit converts the image signal into an optical signal. A polygonal mirror reflects the optical signal, which passes through lenses and is reflected by reflecting mirrors. Accordingly, a circumferential surface of the photosensitive drum 1 is irradiated with an optical image E.

The photosensitive drum 1 is rotated during image formation. The photosensitive drum 1 is discharged with the pre-exposure lamp, and then uniformly charged with the charging unit. The photosensitive drum 1 is irradiated with an optical image E of a first color, thereby forming a latent image on the photosensitive drum 1. Then, the latent image on the circumferential surface of the photosensitive drum 1 is developed with a developer, thereby forming a toner image on the circumferential surface of the photosensitive drum 1, using a toner having a base substance made of resin and pigment. Then, the toner image on the photosensitive drum 1 is primarily transferred on the intermediate transfer member 3.

After the development of the first color, the rotary developing unit 5 is rotated by 90 degrees in the direction indicated by arrow a in FIG. 1. Accordingly, a developer of a second color is moved to the development position facing the photosensitive drum 1. Then, after the primary transfer for the first color is completed and the cleaning unit 4 performs cleaning, the photosensitive drum 1 repeat processes including formation of a latent image, development, and primary transfer, for the second color, a third color, and a fourth color, in a manner similar to the first color, to sequentially superpose toner images of all colors on the intermediate transfer member 3. Herein, a developer is supplied with a toner as necessary from a toner storage unit so that a toner ratio (or toner amount) in the developer is kept constant.

Meanwhile, a recording sheet on which an image is to be recorded is fed one by one from one of sheet storage units 61, 62, 63, and 64 by way of corresponding one of sheet feeding units 71, 72, 73, and 74. A registration roller 75 corrects a skew of a sheet. Then, the sheet is conveyed to a secondary transfer unit 76 at a desired timing.

The secondary transfer unit 76 transfers the toner images on a recording sheet. A sheet conveying unit 77 conveys the recording sheet to a fixing device 6. The fixing device 6 fixes the toner images to the recording sheet by heating. Then, the recording sheet is conveyed to a curl correcting device 90 according to an embodiment of the present invention. The curl correcting device 90 corrects a curl. An external sheet-output-roller pair 92 outputs the recording sheet on a sheet output tray 65. Or, the recording sheet is conveyed to a sheet post-processing device (not shown).

When images are to be formed on both first and second sides of a recording sheet, the fixing device 6 of the image forming unit fixes a toner image to a first side of the recording sheet by heating, and a conveying path switch guide is driven, so as to guide a front edge of the recording sheet to a reversing path 66. Then, a reversing roller 78A is reversely rotated when a sensor 9 detects a rear edge of the recording sheet. The recording sheet is conveyed to a duplex conveying path 67 in a direction opposite to a feeding direction while the rear edge of the recording sheet is conveyed ahead. Then, a conveying roller 79 in the duplex conveying path 67 conveys the recording sheet to the registration roller 75. A toner image is transferred on a second side of the recording sheet by the above-described image formation process. Then, the fixing device 6 fixes the toner image. A sheet-output-roller pair 80 conveys the recording sheet, with the toner image fixed thereto, to the curl correcting device 90. After a curl is corrected, the external sheet-output-roller pair 92 outputs the recording sheet on the sheet output tray 65. Or the recording sheet is conveyed to the sheet post-processing device (not shown).

When a recording sheet with an image formed on a first side thereof is to be reversed and output, after the fixing device 6 of the image forming unit fixes a toner image to the first side of the recording sheet by heating, the conveying path switch guide is driven, so as to guide a front edge of the recording sheet to the reversing path 66. Then, a reversing roller 78B is reversely rotated when the sensor 9 detects a rear edge of the recording sheet. The recording sheet is conveyed to the curl correcting device 90 in the direction opposite to the feeding direction while rear edge of the recording sheet is conveyed ahead. The recording sheet with a curl corrected is output on the sheet output tray 65. Or the recording sheet is conveyed to the sheet post-processing device (not shown).

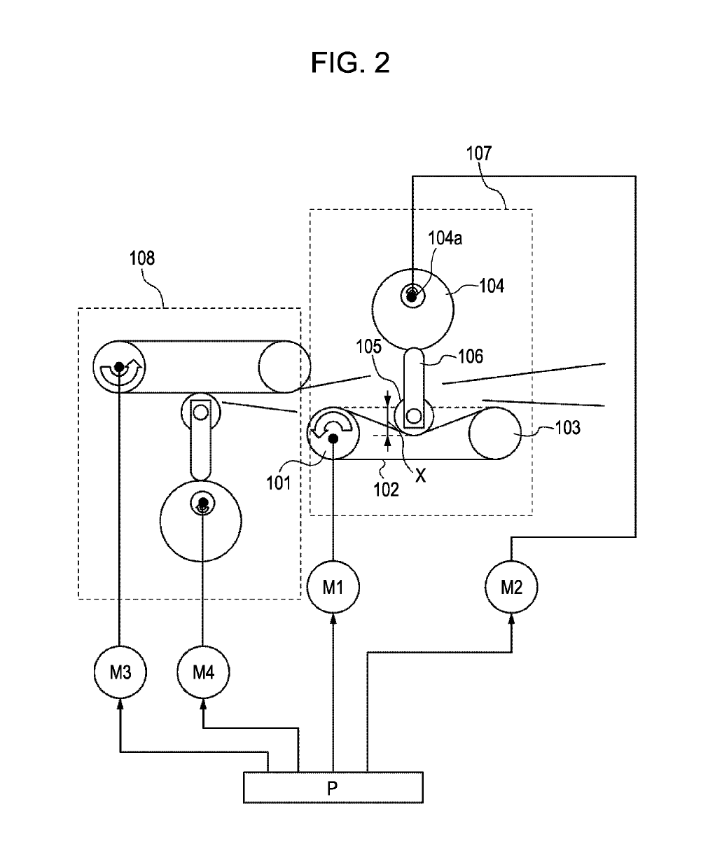

Next, the curl correcting device 90 mounted on the image forming apparatus is described with reference to FIG. 2 according to an embodiment of the present invention.

The curl correcting device 90 includes a pair of curl correcting assemblies 107 and 108. The curl correcting assembly 107 includes an endless belt 102 made of rubber and extending between a driving roller 101 and a driven roller 103. The driving roller 101 is rotationally driven with a stepping motor M1 via gears (not shown). The driven roller 103 is driven with the rotation of the driving roller 101. The curl correcting assembly 107 also includes a pressing roller 105 that presses a belt surface of the endless belt 102. A contact-pressure portion between the endless belt 102 and the pressing roller 105 defines a curved belt-nip portion (curl-correcting nip portion). A recording sheet is conveyed through the curved belt-nip portion, and hence, a curl is corrected. The number of rotations of the stepping motor M1 can be changed by changing the number of pulses input to the stepping motor M1, and thus, the number of rotations of the driving roller 101 can be changed.

The pressing roller 105 is held at an end of a pressing roller holder 106, and movably supported thereby so as to press the belt surface of the endless belt 102 in a direction perpendicular to the belt surface. The other end of the pressing roller holder 106 slidably abuts on a pressure cam 104 that is driven with a stepping motor M2 via gears (not shown). The pressure cam 104 causes the pressing roller 105 to press the belt surface of the endless belt 102 so that the endless belt 102 is curved. The pressing roller holder 106 is biased with a resilient member such as a spring (not shown) so that the other end of the pressing roller holder 106 slidably abuts on a circumferential surface of the pressure cam 104. A pressing amount X of the pressing roller 105 to the endless belt 102 can be changed by a rotation of the pressure cam 104 around a rotation center 104a thereof. The pressing amount X can be determined in accordance with a rotation angle. That is, the rotation angle of the pressure cam 104 is determined on the basis of the number of pulses of the stepping motor M2, and thus the pressing amount X is determined. The above mentioned configurations are integrally arranged, defining the curl correcting assembly 107.

The curl correcting assembly 108 is arranged downstream of the curl correcting assembly 107 in a sheet conveying direction. The curl correcting assembly 108 has a similar, but vertically inverted arrangement to that of the curl correcting assembly 107. In the curl correcting assembly 108, a driving roller 101 is driven with a stepping motor M3, and a pressure cam 104 is driven with a stepping motor M4. The number of rotations of the stepping motor M3 can be changed by changing the number of pulses input to the stepping motor M3, and thus, the number of rotations of the driving roller can be changed.

When a recording sheet has an upward curl (curl having an upwardly protruding shape), the curl is corrected when passing through a curved path defined by the curved belt-nip portion between the pressing roller 105 and the endless belt 102 in the curl correcting assembly 107. Herein, a curl correcting amount is adjustable by changing the pressing amount X of the pressing roller 105 to the endless belt 102. When a recording sheet has a downward curl (curl having a downwardly protruding shape), the curl is corrected with the curl correcting assembly 108 similarly.

As described above, since the curl correcting assembly 107 or 108 is selectively used in accordance with a direction of a curl being generated at a recording sheet, the curl can be properly corrected. It is noted that while one of the curl correcting assemblies corrects a curl, the other one, which does not correct the curl, is controlled so that the pressing amount X becomes zero, or the pressing roller 105 thereof is moved away from the endless belt 102 so as not to make an effect on the recording sheet.

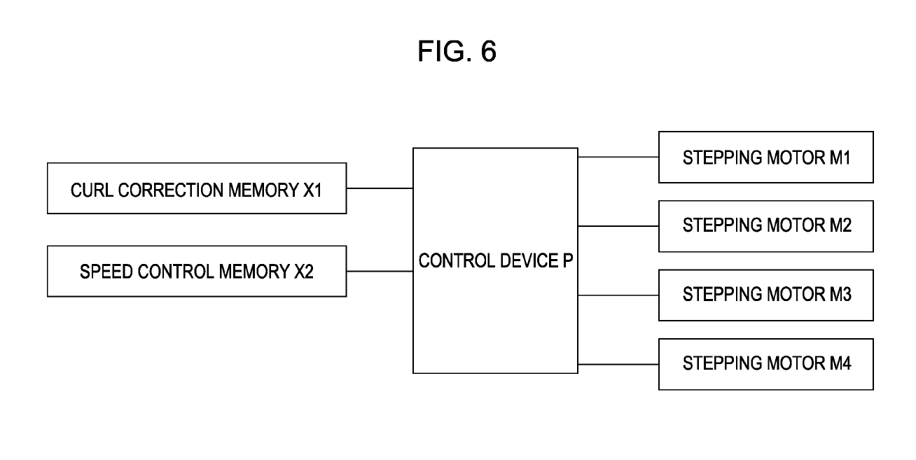

The size and direction of a curl being formed at a recording sheet may be varied in accordance with a type of recording sheet, such as a basis weight, a material, or a size of a recording sheet; or an image forming condition, such as an application amount of a toner on a recording sheet, or a pressure at the fixing device. Owing to this, sizes and directions of curls expected to be generated in accordance with types of recording sheets or image forming conditions, are experimentally or theoretically acquired in advance. Then, conditions for correcting the acquired curls are stored in advance in a curl correction memory X1 (see FIG. 6). The conditions for correcting the curls may include pressing amounts of the pressing roller 105 respectively corresponding to the sizes of the curls, or selection between the curl correcting assemblies 107 and 108 in accordance with the directions of the curls. In addition, speed conditions of the endless belt 102 are also stored in advance in a speed control memory X2 (see FIG. 6). This is described later.

The driving of the stepping motors M1 and M2 (M3 and M4) is controlled with a control device P (see FIG. 6). The control device P controls a pulse per second (PPS) of the stepping motor M1 (M3) on the basis of a condition stored in the above-mentioned speed control memory X2. Also, the control device P controls the number of pulses of the stepping motor M2 (M4) on the basis of a condition stored in the curl correction memory X1. As described above, since the control device P controls the stepping motors M1 and M2, the speed of the endless belt 102 and the pressing amount of the pressing roller 105 are properly determined via the driving roller 101. The control device P also controls the curl correcting assembly 108 similarly.

Now, referring to FIG. 6, a block diagram showing a control unit of the curl correcting device 90 is described according to the embodiment.

The curl correction memory X1 and the speed control memory X2 are connected to the control device P. When a type of recording sheet on which an image is to be formed, and an image forming condition are input, corresponding data is extracted from these memories. Also, the control device P is connected to the stepping motors M1 to M4 to control these motors. The curl correcting assembly 107 or 108 is selected in accordance with the size and direction of a curl, which is to be generated at the recording sheet, on the basis of the data from the curl correction memory X1. The stepping motor M2 or M4 is controlled so that the selected assembly may have a proper pressing amount X of the pressing roller 105. The stepping motor M1 or M3 is controlled to determine the number of rotations of the corresponding driving roller 101 on the basis of the data from the speed control memory X2. The determination of the number of rotations will be described later in more detail.

Next, reasons causing problems of a curl correcting apparatus of a related art are described.

In the curl correcting assembly, it has been experimentally found that the belt speed may be varied at the curved belt-nip portion in accordance with the pressing amount of the pressing roller 105 to the endless belt 102. In particular, as the pressing amount of the pressing roller 105 is increased, the belt speed at the curved belt-nip portion is decreased. That is, the relationship between the pressing amount and the belt speed is expressed as follows:

Va1>Va2, when a1<a2,

where Va1 is a speed of the endless belt 102 when it is assumed that a1 is a pressing amount of the pressing roller 105, and Va2 is a speed of the endless belt 102 when it is assumed that a2 is a pressing amount of the pressing roller 105.

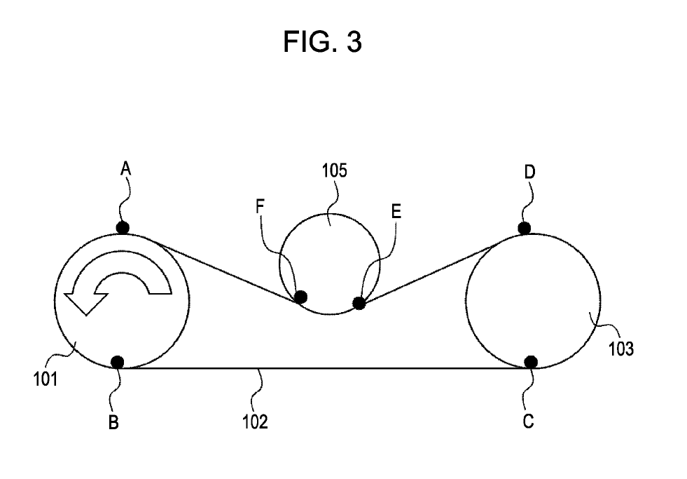

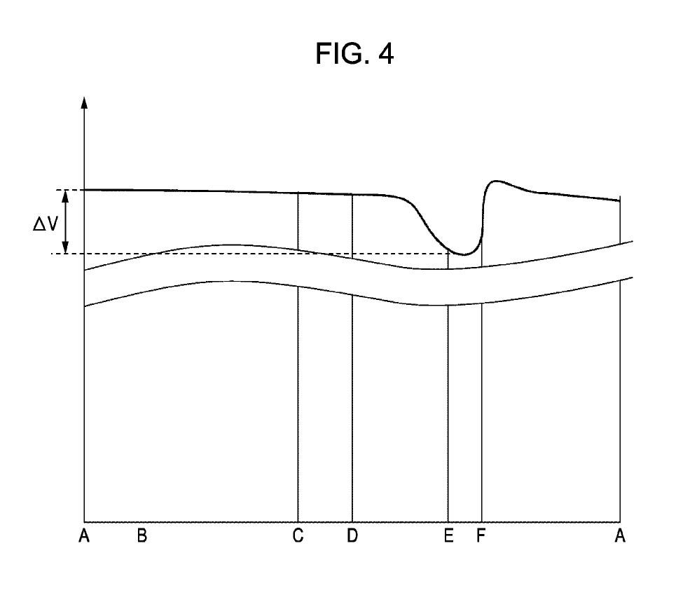

The state of the belt speed is described below with reference to the curl correcting assembly 107 as an example. First, referring to FIGS. 3 and 4, a speed distribution of the endless belt 102 while the pressing roller 105 presses the endless belt 102 is described.

In FIG. 3, it is assumed that a point A represents a point at which winding of the endless belt 102 around the driving roller 101 is started, and a point B represents a point at which winding of the endless belt 102 around the driving roller 101 is ended. Also, a point C represents a point at which winding of the endless belt 102 around the driven roller 103 is started, and a point D represents a point at which winding of the endless belt 102 around the driven roller 103 is ended. Further, a point E represents a point at which winding of the endless belt 102 around the pressing roller 105 is started, and a point F represents a point where winding of the endless belt 102 around the pressing roller 105 is ended.

FIG. 4 shows the speed distribution of the endless belt 102.

First, a constant speed is applied to the endless belt 102 in an area between the points A and B (inclusive). The endless belt 102 gradually becomes dense while passing through an area between the points C and D (inclusive), and the belt speed locally becomes low. The endless belt 102 locally becomes the densest while passing through an area between the points E and F (inclusive), and the belt speed locally becomes the lowest. After passing through the point F, the endless belt 102 locally becomes rare, and the belt speed locally becomes high. The local change in speed is generated because the endless belt 102 is made of a material capable of being slightly expanded and contracted.

Also, it has been found that as the pressing amount X of the pressing roller 105 to the endless belt 102 is increased, a difference ΔV of the local belt speed in the area between the points A and B and the local belt speed in the area between the points E and F is increased.

With such belt speed, the following problems may occur.

(1) For example, the recording sheet conveyed at a sheet conveying speed V1 with the sheet-output-roller pair 80 arranged upstream of the curl correcting assembly 107 is conveyed to the curved belt-nip portion. If the number of rotations of the driving roller 101 is determined to satisfy V1=Va1, V1>Va2 is true when the pressing amount is a2. Accordingly, a loop of a recording sheet may be generated between the curved belt nip portion and the sheet-output-roller pair 80 arranged upstream of the curl correcting assembly 107. Thus, a loop mark may remain at the recording sheet to be conveyed. If a loop amount is large, a jam (sheet jam) may occur. In particular, if a thin sheet having a small basis weight is used, the recording sheet may have a small hardness. Thus, the sheet may easily cause a jam due to the loop.

(2) If the number of rotations of the driving roller 101 is determined to satisfy V1=Va2, V1<Va1 is true when the pressing amount of the pressing roller 105 is a1. For example, if a sheet conveying force of the sheet-output-roller pair 80 arranged upstream of the curl correcting assembly 107 is larger than a sheet conveying force at the curved belt-nip portion, a recording sheet may slip at the curved belt-nip portion. Accordingly, a slip mark caused by the curved belt-nip portion may remain at the recording sheet or an image fixed to the recording sheet.

In contrast, if the sheet conveying force at the curved belt-nip portion is larger than the sheet conveying force of the sheet-output-roller pair 80 arranged upstream of the curl correcting assembly 107, a recording sheet may slip at a nip portion of the sheet-output-roller pair 80. Accordingly, a slip mark caused by the sheet-output-roller pair 80 may remain at the recording sheet or an image fixed to the recording sheet.

In particular, if the curl correcting device 90 is arranged close to the fixing device of the image forming apparatus, since a recording sheet is not cooled, an image formed on the recording sheet may not be completely fixed. Hence, the slip mark caused by the sheet-output-roller pair 80 or the slip mark caused by the curved belt-nip portion may remain noticeably.

(3) If the sheet conveying force at the curved belt-nip portion is larger than the sheet conveying force of the sheet-output-roller pair 80 arranged upstream of the curl correcting assembly 107, for example, the following expression is established:

Va1>Va2

where Xa1 is the number of sheets to be produced for one minute with a pressing amount a1, and Xa2 is the number of sheets to be produced for one minute with a pressing amount a2. Accordingly, Xa1>Xa2 is true. That is, a productivity of image formation may be varied markedly because of the pressing amount of the pressing roller 105.

The embodiment of the present invention is provided to analyze and overcome such problem.

The sheet conveying speed of the recording sheet is determined in accordance with the belt speed at the curved belt-nip portion where the pressing roller 105 presses the endless belt 102. That is, the sheet conveying speed is determined by a mean value of the local belt speeds in the area between the points E and F as shown in FIGS. 3 and 4.

Hence, in the curl correcting device 90 according to this embodiment, the speed of the driving roller 101 is changed in accordance with the pressing amount X of the pressing roller 105, so as to control the sheet conveying speed of the recording sheet passing through the curved belt-nip portion where the pressing roller 105 presses the endless belt 102. The speed control is permitted unless the speed is decreased at the curved belt-nip portion and the recording sheet to be conveyed is delayed, resulting in seriously decreasing the productivity, or unless an excessive loop is formed at the recording sheet and the recording sheet is pulled, resulting in causing a noticeable slip.

Accordingly, the speed difference between the sheet conveying speed of the recording sheet passing through the curved belt-nip portion between the pressing roller 105 and the endless belt 102, and the sheet conveying speed of the sheet-output-roller pair 80 arranged upstream of the curl correcting assembly 107 can be reduced. Also, the speed difference between the sheet conveying speed of the recording sheet passing through the curved belt-nip portion between the pressing roller 105 and the endless belt 102, and the sheet conveying speed of the external sheet-output-roller pair 92 arranged downstream of the curl correcting assembly 108 can be reduced.

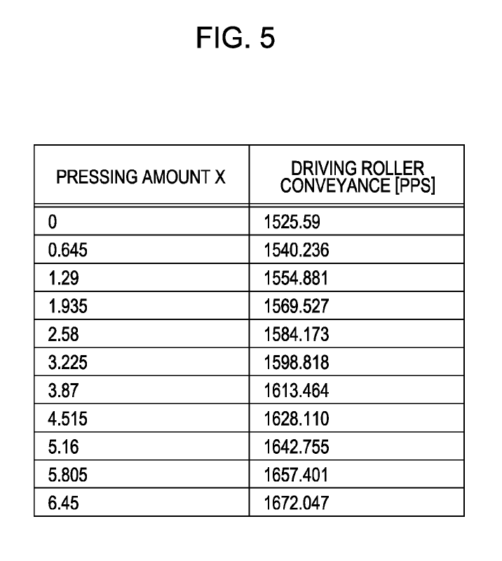

FIG. 5 is a relationship table showing a relationship between a pressing amount X of the pressing roller 105 and an input pulse of the stepping motor M1 serving as the driving source of the driving roller 101. As the number of input pulses is increased, the rotation speed of the driving roller 101 is increased. The relationship table is stored in the speed control memory X2 (see FIG. 6). The data for the number of pulses is extracted from the speed control memory X2 in accordance with the pressing amount X of the pressing roller 105, and hence, the driving speed of the driving roller 101 is determined.

Referring to the relationship table, it is found that as the pressing amount X is increased, the rotation speed of the driving roller 101 is increased. In particular, the belt speed in the area between the points E and F in FIG. 4 is decreased as the pressing amount X is increased, and thus, the belt speed is increased accordingly. The relationship table is provided so that a recording sheet can be properly conveyed on the basis of an experiment.

While the relationship table provides each ten steps for the pressing amount X and the speed of the driving roller 101 in this embodiment, the number of steps is not limited thereto. Also, numerical values may be changed in accordance with a diameter of the pressing roller 105, or a length of the endless belt 102.

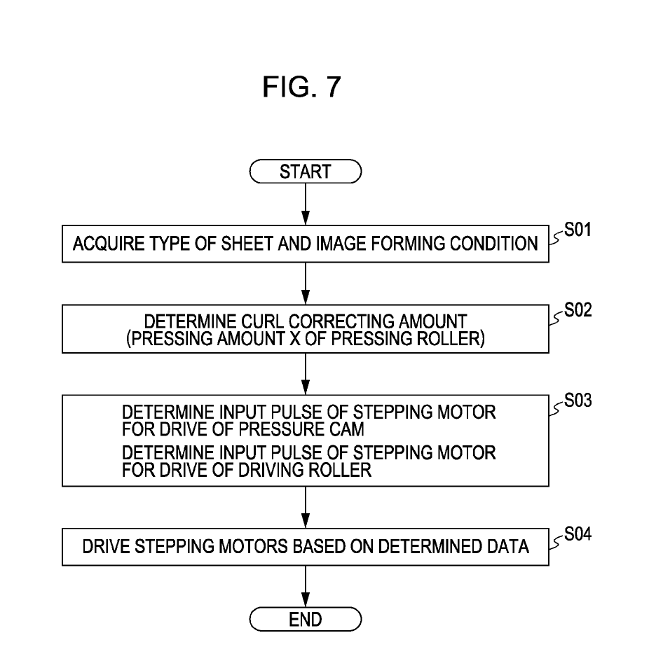

Next, control of the curl correcting device 90 according to the embodiment is described with reference to a flowchart in FIG. 7.

First, a type of recording sheet such as a size or a basis weight of a recording sheet, and an image forming condition such as image density information of an image to be formed on the recording sheet are acquired (step S01). Data is extracted from the curl correction memory X1 on the basis of the acquired information. Then, one of the curl correcting assemblies to be used is selected, and a curl correcting amount (pressing amount X) is determined (step S02). An input pulse of a stepping motor to drive a pressure cam in accordance with the curl correcting amount is extracted from the curl correction memory X1, and is determined. Simultaneously, a pulse per second of a stepping motor serving as a driving source of the driving roller 101 is extracted from the speed control memory X2, and is determined (step S03).

Then, the stepping motors of the curl correcting assembly selected on the basis of the data determined as described above are operated, and a curl of a recording sheet to be conveyed is corrected (step S04).

Accordingly, a curl of a recording sheet can be corrected using the curl correcting assembly with the number of rotations of the driving roller 101 and the pressing amount X of the pressing roller 105 determined. The correction of a curl allows a recording sheet to be straight, or to have a direction and a size optimal to post processing with a post-processing device.

The present invention is not limited to the configurations of the embodiments. For example, while the present invention is applied to the curl correcting device 90 arranged downstream of the fixing device 6, the present invention may be applied to a curl correcting device provided in a duplex conveying path or a post-processing device.

While the embodiment employs the configuration in which the pair of curl correcting assemblies of the curl correcting device is arranged in series in the sheet conveying direction, a pair of curl correcting assemblies may be arranged in parallel. In particular, the conveying path is split at an upstream position of the curl correcting assemblies in the sheet conveying direction, and the pair of curl correcting assemblies is arranged vertically. A recording sheet may be conveyed to one of the curl correcting assemblies in accordance with a direction of a curl of the recording sheet, and the curl may be corrected.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-167458 filed Jun. 26, 2007, which is hereby incorporated by reference herein in its entirety.

What is claimed is:

1. A curl correcting device configured to correct a curl of a sheet, comprising:
an endless belt extending between a driving roller configured to be rotationally driven and a driven roller configured to be driven with the driving roller; and
a pressing roller configured to press a belt surface of the endless belt,
wherein the sheet is conveyed through a curved belt-nip portion between the pressing roller and the endless belt so as to correct the curl of the sheet, and
wherein a rotation speed of the driving roller is changeable in accordance with a pressing amount of the pressing roller to the endless belt.

2. The curl correcting device according to claim 1, wherein the rotation speed of the driving roller is increased as the pressing amount of the pressing roller to the endless belt is increased, so as to increase a belt speed of the endless belt.

3. The curl correcting device according to claim 1, wherein the pressing amount of the pressing roller to the endless belt is determined in accordance with a rotation angle of a pressure cam configured to move the pressing roller.

4. The curl correcting device according to claim 1, wherein a pair of curl correcting assemblies each having the endless belt and the pressing roller is provided, the curl correcting assemblies being arranged so as to correct curls in different directions, one of the curl correcting assemblies being selected in accordance with a direction of the curl of the sheet to be corrected, to correct the curl.

5. An image forming apparatus having an image forming unit configured to form an image on a sheet and a curl correcting device configured to correct a curl of the sheet having the image formed thereon with the image forming unit, comprising:
an endless belt extending between a driving roller configured to be rotationally driven and a driven roller configured to be driven with the driving roller; and
a pressing roller configured to press a belt surface of the endless belt,
wherein the sheet is conveyed through a curved belt-nip portion between the pressing roller and the endless belt so as to correct the curl of the sheet, and
wherein a rotation speed of the driving roller is changeable in accordance with a pressing amount of the pressing roller to the endless belt.

6. The image forming apparatus according to claim 5, wherein the rotation speed of the driving roller is increased as the pressing amount of the pressing roller to the endless belt is increased, so as to increase a belt speed of the endless belt.

7. The image forming apparatus according to claim 5, wherein the pressing amount of the pressing roller to the endless belt is determined in accordance with a rotation angle of a pressure cam configured to move the pressing roller.

8. The image forming apparatus according to claim 5, further comprising a pair of curl correcting assemblies each having the endless belt and the pressing roller, the curl correcting assemblies being arranged so as to correct curls in different directions, one of the curl correcting assemblies being selected in accordance with a direction of the curl of the sheet to be corrected, to correct the curl.

9. The image forming apparatus according to claim 5,
wherein the image forming unit includes a transfer unit configured to transfer a toner image on the sheet, and a fixing device configured to fix the toner image by heating the sheet with the toner image transferred thereon, and
wherein the curl correcting device is arranged downstream of the fixing device.
